(19) United States
(12) Patent Application Publication
(10) Pub. No.: US 2016/0350756 A1
(43) Pub. Date: Dec. 1, 2016

(54) CONSUMER RETURN OF DEFECTIVE PRODUCTS VIA MOBILE DEVICE PHOTOGRAPH SUBMISSION

(71) Applicant: TeleCommunication Systems, Inc., Annapolis, MD (US)

(72) Inventors: Margaret Skalko Shepard, Annapolis, MD (US); Richard Reed Ruth, Churchton, MD (US); Lewis Nichols Tuttle, Queenstown, MD (US)

(21) Appl. No.: 14/724,926

(22) Filed: May 29, 2015

(51) Int. Cl. G06Q 20/40; G06K 9/00; G06K 9/22; G06K 9/34; H04N 1/00; G06K 9/72

(52) U.S. Cl. CPC G06Q 20/407; H04N 1/00244; G06K 9/723; G06K 9/228; G06K 9/344; G06K 9/00463; G06K 2209/01; H04N 2201/0084

(57) ABSTRACT

A refund requesting device can include a camera, an optical character recognition (OCR) module, and a transmitter. The camera can capture a defective product photograph of a defective product and a receipt photograph of a purchase receipt for the defective product. The optical character recognition (OCR) module can optical character recognize the receipt photograph to produce receipt textual data. The transmitter can transmit, to a refund processing server, a refund request message comprising at least one of the defective product photograph and the receipt textual data. The refund processing server can processes the refund request message to add a refund money amount to an account associated with a purchaser of the defective product.

### BACKGROUND OF THE INVENTION

1. Field of the Invention

The present invention relates to defective products. More particularly, the present invention relates to return of defective products.

2. Background of Related Art

Consumers purchasing defective products has become commonplace. An example of a defective product that almost all consumers have purchased is produce from a grocery store. Produce purchases are a luck of the draw affair. Purchasing the same product from the same grocer on a different day results in a totally different experience for the consumer. One instance results in great produce while another instance results in inedible produce. Conventionally, most consumers simply throw away bad produce.

Another example of a defective product is a manufacturer recall. Manufacturers typically recall consumer products when such consumer products pose a health risk to consumers. Recalled products are becoming too commonplace. Recalled products can range from lettuce, ground beef, ice cream, bagged salad, yogurt, toasters, televisions, batteries, computers, cars, etc.

When consumers purchase defective products such as inedible or recalled produce, most consumers simply throw away the purchase because of a lack of convenience of returning such defective products. The lack of convenience can be related to, e.g., the distance to the grocery store being too great to make a return of the purchase worthwhile, a consumer not having the time to immediately return to the grocery store, saving the purchase for a later return requires the consumer to remember to take the defective product to the grocery store on a subsequent trip to the grocery store (which most consumers fail to do), etc.

Throwing away inedible produce creates ill will toward a particular grocery store, leading some consumers to stop purchasing produce from that particular grocery store. For that particular grocery store, sales of produce could decline without that particular grocery store having knowledge of why such sales are declining.

Accordingly, there is a need for a way for a consumer to more conveniently return defective product purchases, and a need for a retailer of a defective product to know that a consumer is dissatisfied with a purchase from the retailer.

### SUMMARY OF THE INVENTION

In accordance with the principles of the present invention, a refund requesting device can comprise a camera, an optical character recognition (OCR) module, and a transmitter. The camera can capture a defective product photograph of a defective product, and a receipt photograph of a purchase receipt for the defective product. The optical character recognition (OCR) module can optical character recognize the receipt photograph to produce receipt textual data. The transmitter can transmit, to a refund processing server, a refund request message comprising at least one of the defective product photograph and the receipt textual data. The refund processing server can process the refund request message to add a refund money amount to an account associated with a purchaser of the defective product.

A method of requesting a refund for a defective product in accordance with another aspect of the present invention can comprise capturing, with a camera of a refund requesting device, a defective product photograph of the defective product and a receipt photograph of a purchase receipt; optical character recognizing, with an optical character recognition (OCR) module of the refund requesting device, the receipt photograph to produce receipt textual data; and transmitting, to a refund processing server with a transmitter of the refund requesting device, a refund request message comprising the receipt textual data and the defective product photograph. The refund processing server can apply a refund money amount for the defective product to an account associated with a purchaser of the defective product.

In accordance with yet another aspect of the present invention, a refund processing server can comprise a receiver, a graphic user interface (GUI), and an account access module. The receiver can receive a refund request message from a refund requesting device, the refund request message can comprise at least a defective product photograph of a defective product. The GUI can display the defective product photograph. The account access module can add a money amount to an account associated with a purchaser of the defective product in response to the refund request message.

A refund processing method in accordance with yet another aspect of the present invention can comprise receiving, via a receiver of a refund processing server, a refund request message from a refund requesting device, the refund request message comprising at least a defective product photograph of a defective product; displaying, via a graphic user interface (GUI) of the refund processing server, the defective product photograph; and accessing, via an account access module of the refund processing server, an account of a purchaser of the defective product to add a refund money amount to the account.

### BRIEF DESCRIPTION OF THE DRAWINGS

Features and advantages of the present invention will become apparent to those skilled in the art from the following description with reference to the drawings, in which:

FIG. 1 illustrates relevant features of an exemplary refund processing system, in accordance with the principles of the present invention.

FIG. 2 illustrates relevant features of the exemplary refund processing server shown in FIG. 1, in accordance with the principles of the present invention.

FIG. 3 illustrates relevant features of an exemplary refund processing server process for processing a refund for a defective product, in accordance with the principles of the present invention.

FIG. 4 illustrates relevant features of the exemplary mobile device shown in FIG. 1, in accordance with the principles of the present invention.

FIG. 5 illustrates relevant features of an exemplary mobile device process for initiating a process of refunding a defective product, in accordance with the principles of the present invention.

### DETAILED DESCRIPTION OF ILLUSTRATIVE EMBODIMENTS

The present inventors have appreciated that there is a need for a convenient way to return, i.e., receive a refund for, a defective product. In particular, the inventors have appreciated a need to receive the refund for the defective product that eliminates a purchaser of the defective product having to drive back to a place of purchase or ship a defective product back to a manufacturer to receive a refund.

The present invention can be comprised of a mobile device that includes Short Message Service (SMS), Multimedia Messaging Service (MMS) and/or email, and photography capabilities. A purchaser of a defective product can be notified by SMS, MMS, and/or email that a defective product has been recently recalled. In response to such notification, the mobile device can utilize the SMS, MMS and/or email messaging capabilities to transmit, to a refund processing server, a digital photograph of a defective product captured with a camera of the mobile device. The refund processing server can utilize the received photograph of the defective product as a basis of providing a refund money amount to a purchaser of the defective product.

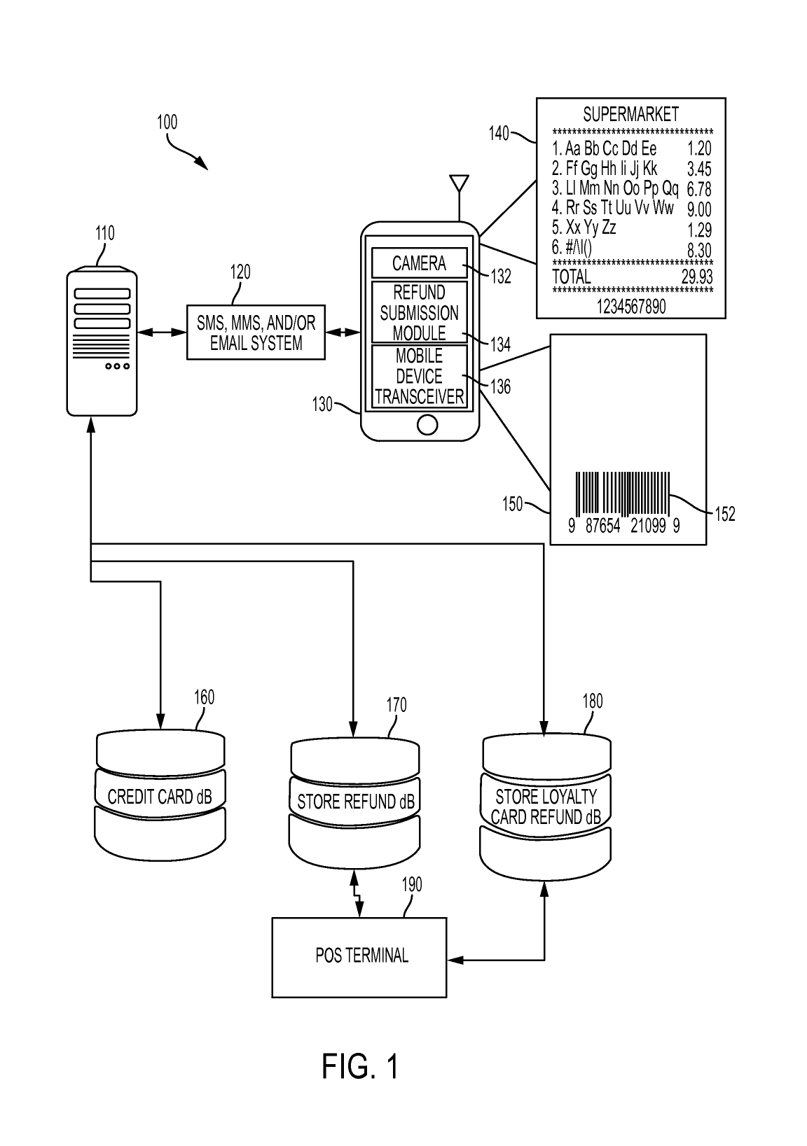

FIG. 1 illustrates relevant features of an exemplary refund processing system 100, in accordance with the principles of the present invention. In particular, the refund processing system 100 can comprise various physical apparatuses that include a refund processing server 110, an SMS, MMS and/or email system 120, a mobile device 130, a credit card database (dB) 160, a store refund dB 170, a store loyalty card dB 180, and a point-of-sale (POS) terminal 190. The mobile device 130 can comprise a camera 132, a refund submission module 134, and a mobile device transceiver 136. The mobile device transceiver 136 can transmit and receive at least one of SMS, MMS and/or email messages via SMS, MMS and/or email system 120. In accordance with the principles disclosed herein, the mobile device transceiver 136 can transmit and receive any type of message that allows the mobile device to request a refund.

The mobile device 130 can capture a photograph of the receipt 140 and the defective product 150. In one embodiment, the mobile device 130 can take a separate photograph of identifying information 152, e.g., a Universal Product Code (UPC), lot information indicating a particular quantity of products produced by a particular manufacturer, a produce sticker identifying a particular type of produce, manufacturer serial number sticker, etc. In one embodiment, the mobile device 130 can take a photograph of a destroyed version of the defective product 150 to assure a manufacturer that the defective product 150 is no longer being used, as a basis to receive a refund. The mobile device 130 can send, via the SMS, MMS and/or email system 120, one or more photographs associated with the defective product 150 to the refund processing server 110.

The refund processing server 110 can include a graphic user interface (GUI), discussed in more detail below, to allow approval personnel to review a refund submission. If a refund request is approved for refund, the refund processing server 110 can transmit a refund money amount to any of the credit card dB 160, the store refund dB 170, and the store loyalty card dB 180. If more than one option is available as a destination for a refund, e.g., a customer paid by credit card and also has a store loyalty card, the submission module 134 can provide options to a user of the mobile device 130 as to how the customer would like the refund received, and apply the refund money amount to one of the credit card dB 160, the store refund dB 170, and the store loyalty card dB 180 accordingly.

When a purchaser of the defective product 150 that has an outstanding refund money amount uses the POS terminal 190, a previously processed refund money amount can be deducted from a most recent purchase. The POS terminal 190 can search the store refund dB 170 for a refund money amount once a cashier receives identification for a purchaser and/or automatically search the store loyalty card dB 180 for a refund money amount once a purchaser enters a store loyalty number into the POS terminal 190 during the most recent purchase.

In one embodiment the refund processing server 110 can perform Optical Character Recognition (OCR) on at least one of the receipt 140 and/or the identifying information 152. In one embodiment, the mobile device 130 can perform OCR on at least one of the receipt 140 and/or the identifying information 152.

The apparatuses 110, 120, 130, 160, 170, 180 of the refund processing system 100 can include various physical components (not shown) required for operability that include, e.g., an appropriate processor, microprocessor, microcontroller, digital signal processor (DSP), digital storage (e.g., random access memory (RAM), read-only memory (ROM), hard disk (HD) storage, solid state disk (SSD) storage), a screen, input devices (e.g., keyboard, mouse, camera), output devices, communication devices, etc. The apparatuses 110, 120, 130, 160, 170, 180 can execute one or more operating systems.

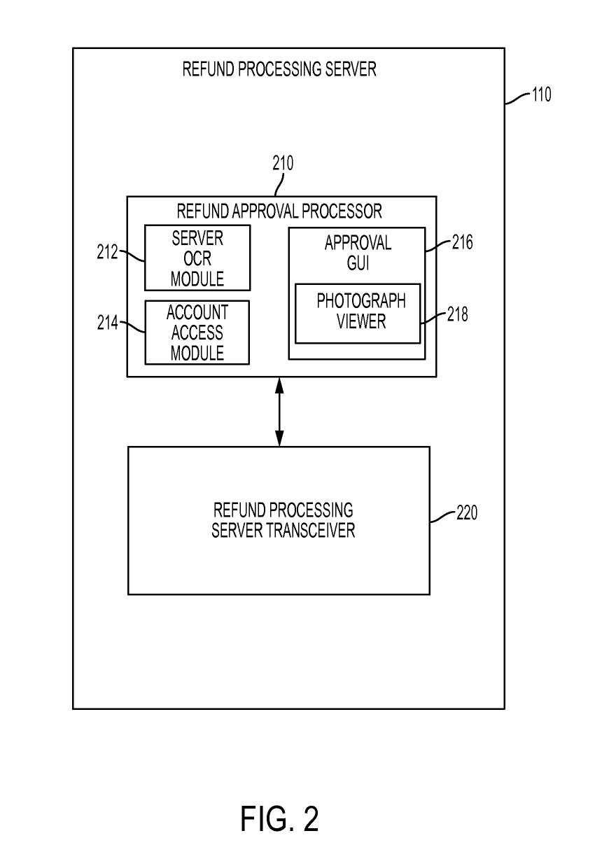

FIG. 2 illustrates relevant features of the exemplary refund processing server shown in FIG. 1, in accordance with the principles of the present invention. In particular, the refund processing server 110 can comprise a refund approval processor 210 and a refund processing server transceiver 220. The refund processing server transceiver 220 can transmit and receive at least one of SMS, MMS, and/or email messages. In accordance with the principles disclosed herein, refund processing server transceiver 220 can transmit and receive any type of message that allows the refund processing server to receive a refund request message. The refund approval processor 210 can include a server OCR module 212, an account access module 214, and an approval GUI 216. The approval GUI can include a photograph viewer 218.

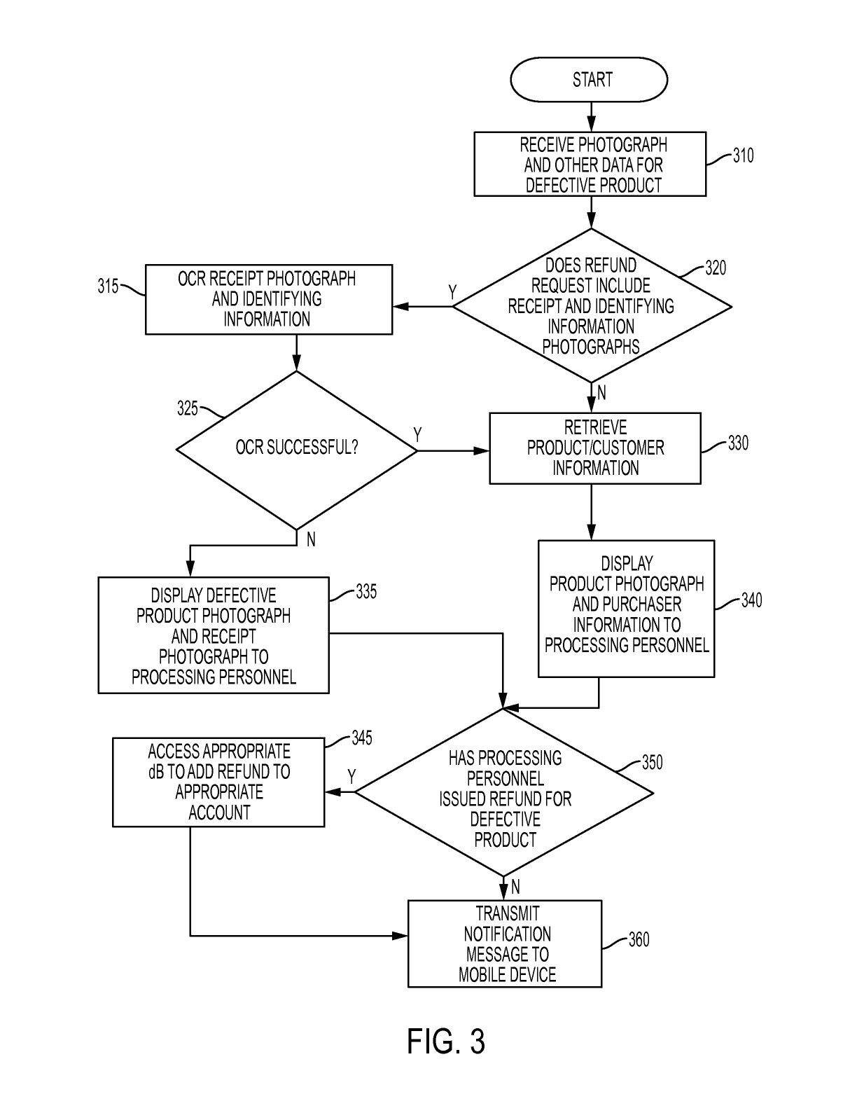

FIG. 3 illustrates relevant features of an exemplary refund processing server process 300 for processing a refund for a defective product 150, in accordance with the principles of the present invention.

The functions of the components of the exemplary refund processing server 110 shown in FIGS. 1 and 2 will be described with reference to FIG. 3.

In step 310 the refund processing server 110 can receive, via the refund processing server transceiver 220, a refund request message comprising one or more photographs, and in one embodiment textual data associated with the receipt 140 and identifying information 152. Textual data can include letters and/or numbers. Such photographs can include a photograph of the defective product 150 for which a consumer desires to receive a refund for. In one embodiment in which OCR is performed by the refund processing server 110, the refund processing server 110 can also receive a photograph of the receipt 140 and a photograph of any identifying information 152 for the defective product 150. In one embodiment in which OCR is performed by the mobile device 130, the refund processing server 110 can receive metadata providing an indication that the defective product 150 had been identified by the mobile device 130 on the receipt 140 and by the identifying information 152. Step 310 can branch to step 320.

In step 320, the refund approval processor 210 of the refund processing server 110 can determine whether the photographs received in step 310 include a photograph of the receipt 140 and a photograph of the identifying information 152 for the defective product 150, or whether metadata was received in step 310 indicating that a photograph of the receipt 140 and a photograph of the identifying information 152 was OCRed and processed by the mobile device 130. If step 320 determines that a photograph of the receipt 140 and a photograph of the identifying information 152 for the defective product 150 was received in step 310, step 320 branches to step 315. If step 320 determines that metadata indicating that the receipt 140 and the identifying information 152 had been OCRed by the mobile device 130 was received in step 310, step 320 branches to step 330.

In step 315, the server OCR module 212 of the refund processing server 110 can perform OCR on a photograph of the receipt 140 and on a photograph the identifying information 152. Step 315 can branch to step 325.

In step 325, the refund approval processor 210 of the refund processing server 110 can determine if the OCR performed in step 315 is successful. If the OCR performed in step 315 is determined to be unsuccessful, i.e., the data produced by the OCR does not match a format associated with products on receipts and/or does not match a format associated with identifying information placed on products, step 325 branches to step 335. Step 335 provides visual inspection for refund personnel to review the photograph of the receipt 140 and on the photograph the identifying information 152. Otherwise, if the OCR performed in step 315 is determined to be successful, step 325 branches to step 330.

In step 335, the photograph viewer 218 of the approval GUI 216 can present a photograph of the receipt 140, the defective product 150, and the identifying information 152 to refund processing personnel for review. The photograph viewer 218 of the approval GUI 216 can present such photographs on an appropriate computer monitor that allows the refund processing personnel to determine if a submission for refund meets all criteria to receive a refund. Step 335 can branch to step 350.

In step 345, the account access module 214 of the refund processing server 110 can access an appropriate dB 160, 170, 180 to add a refund money amount to an appropriate account associated for a purchaser of the defective product 150. Step 345 can branch to step 360.

For example, the defective product 150 may have been purchased with a credit card as indicated on the receipt 140, the credit card information being stored by a retailer of the defective product 150. A particular retailer may desire to provide all refunds to credit card accounts if such accounts were used in purchasing the defective product 150. In such an instance the account access module 214 can send a refund money amount and associated account data to the credit card dB 160 to credit a particular purchaser. The purchaser can receive notice of the refund money amount from a credit card company.

In one embodiment, all refunds from a particular retailer may go to a store refund dB 170. In such an instance, the account access module 214 can send refund money amount and associated purchaser data, as entered during a submission on a mobile device 130, to the store refund dB 170. The purchaser can then provide identification (e.g., driver license) when visiting the retailer to obtain a refund money amount (e.g., cash or applying a refund money amount to a current purchase).

In another embodiment, if a purchaser of the defective product 150 provides a store loyalty number when submitting a refund request to the refund processing server 110, the account access module 214 can send a refund money amount to a store loyalty card dB 180 associated with the purchaser.

In step 330, the refund approval processor 210 of the refund processing server 110 can retrieve textual defective product information and textual purchaser information identified on receipt 140 and the identifying information 152. The refund approval processor 210 can query appropriate databases, either local or remote, with the OCR textual data produced by the mobile device 130 or the refund processing server 110. Such a query can identify the defective product 150 and the purchaser of the defective product 150 (e.g., based on a store loyalty number), retrieve the textual defective product information (e.g., name of defective product 150) and textual purchaser information (e.g., name of purchaser, address, telephone number, etc.). In one embodiment, the refund approval processor 210 can retrieve a manufacturer photograph for the defective product 150 and display the manufacturer photograph as a basis for refund processing personnel to accept a refund request. Step 330 can branch to step 340.

In step 340, the approval GUI 216 of the refund processing server 110 can display a photograph of the defective product 150, the textual defective product information and textual purchaser information retrieved in step 330 for refund processing personnel. The refund processing personnel can make a determination that the defective product 150 meets certain criteria for refund and that the photograph of the defective product 150 matches the textual defective product information associated with the defective product 150. In one embodiment, the approval GUI 216 can display a photograph of a destroyed version of the defective product 150 to the processing personnel as a basis for determining whether to issue a refund. Step 340 can branch to step 350.

In step 350, the refund approval processor 210 of the refund processing server 110 can determine if the processing personnel issued a refund for a defective product 150. If the processing personnel issued a refund, step 350 branches to step 345. If the processing personnel did not issue a refund, step 350 branches to step 360.

In step 360, the refund approval processor 210 of the refund processing server 110 can transmit, via the refund processing server transceiver 220, a notification to the purchaser that a refund has been issued or a notification that a refund was declined. The refund approval processor 210 can formulate an SMS, MMS and/or email message comprising an appropriate notification. The refund processing server 110 can transmit the SMS, MMS and/or email message to the same mobile device 130 submitting a request for refund, notifying a purchaser of a refund or non-refund. In the event that the refund processing server 110 transmits a notifying message to a purchaser that a refund is being issued for a defective product 150, such a notifying message can indicate the refund money amount and the type of refund being issued, i.e., credit card refund, store refund, and/or store loyalty card refund.

In one embodiment, the refund approval processor 210 can allow refund processing personnel to compare, in step 350, a manufacturer photograph of the defective product 150 with the photograph of the defective product 150 submitted by the mobile device 130. If such photographs match for a particular product, the processing personnel can compare the state of a non-defective product to the state of the defective product 150 submitted for refund by the mobile device 130 as a basis for approving a refund request/declining a refund request.

In one embodiment, the refund approval processor 210 can automatically provide a refund without personnel review for purchasers that have submitted less than a predetermined number of refund requests within a designated period of time, automatically provide a refund for a money amount less that a predetermined money amount, automatically provide a refund for products know to be defective, etc. The refund approval processor 210 can perform pattern matching to verify that a picture of the defective product 150 submitted with a request for refund matches a known pattern for such a product. Such pattern matching can eliminate refund personnel from having to review a picture of the defective product 150. Thus, automatic refunds under such circumstances save refund personnel resources from having to review every refund request for compliance with refund approval criteria.

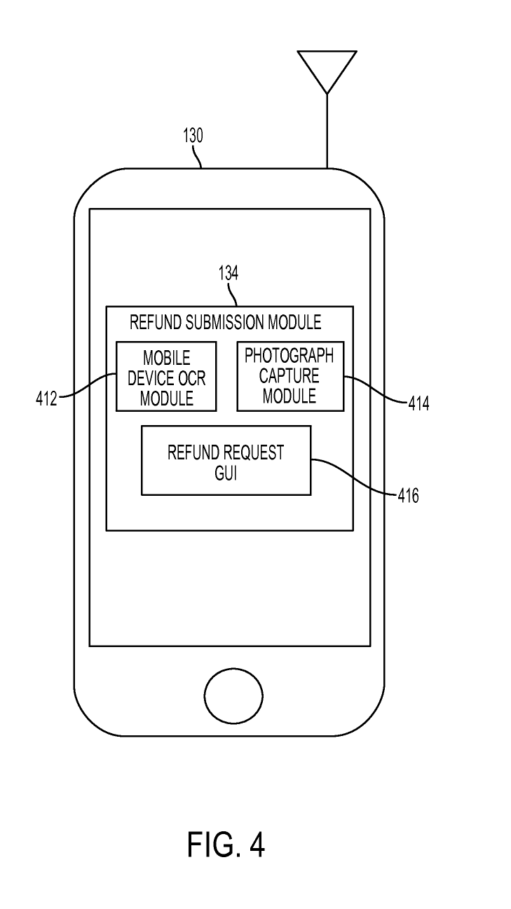

FIG. 4 illustrates relevant features of the exemplary mobile device 130 shown in FIG. 1, in accordance with the principles of the present invention. In particular, the mobile device 130 can comprise a refund submission module 134 that can include a mobile device OCR module 412, a photograph capture module 414, and a refund request GUI 416. The refund submission module 134 can be implemented as an ‘app’ (e.g., iOS app, Android app, etc.), the app being downloadable from an app store.

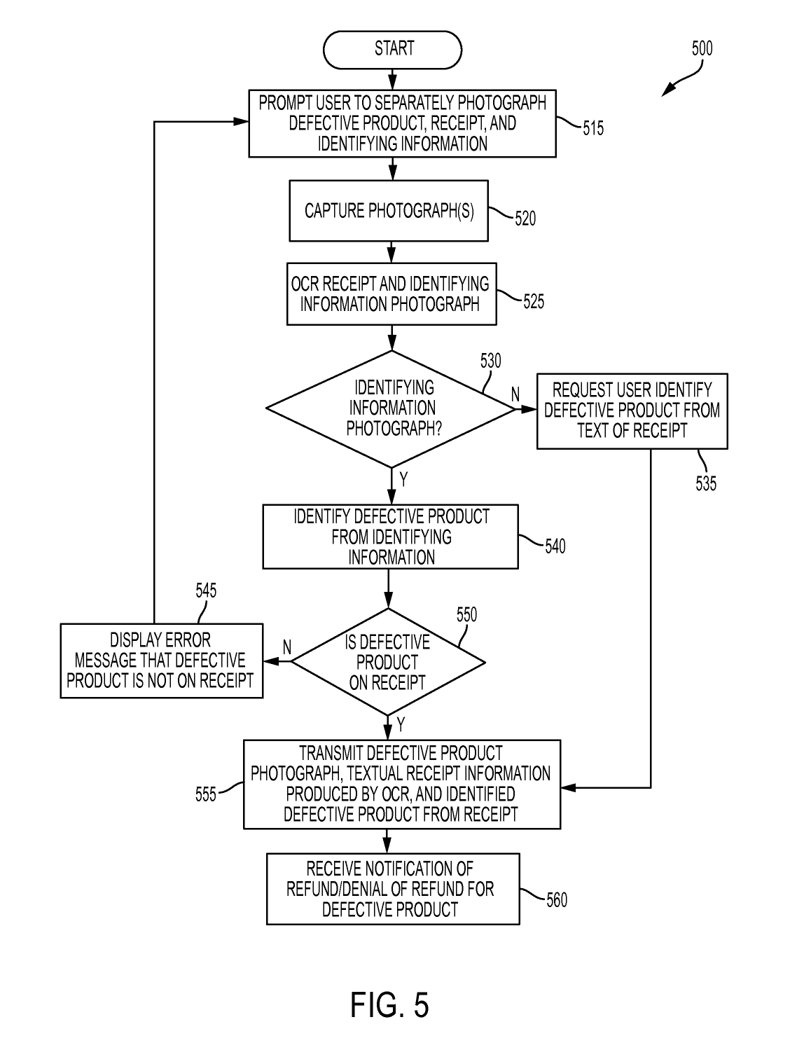

The functions of the components of the exemplary mobile device 130 shown in FIGS. 1 and 4 will be described with reference to FIG. 5.

FIG. 5 illustrates relevant features of an exemplary mobile device process 500 for initiating a process of refunding a defective product 150, in accordance with the principles of the present invention.

In step 515, the refund submission module 134 of the mobile device 130 prompts a user of the mobile device 130 to take a photograph of a defective product 150, the receipt 140, and any identifying information 152 associated with the defective product 150. In one embodiment, the mobile device 130 can prompt the user to separately take a photograph of the defective product 150, the receipt 140 that lists the defective product 150, and identifying information 152 associated with the defective product 150. The mobile device 130 can attach metadata to each photograph captured indicating what information is depicted in each photograph. In one embodiment, a user can take a single photograph that includes all of the information needed to process a refund request. Step 515 can branch to step 520.

In step 520, the photograph capture module 414 of the mobile device 130 can capture one or more photographs. As discussed above, the mobile device 130 can capture a photograph of the defective product 150, the receipt 140 that lists the defective product 150, and identifying information 152 associated with the defective product 150. In one embodiment, the mobile device 130 can capture a photograph of a destroyed version of the defective product 150. In one embodiment wherein the refund processing server 110 instead performs OCR on photographs of the receipt 140 and identifying information 152, photographs of the receipt 140 and identifying information 152 are transmitted to the refund processing server 110 for processing. Step 520 can branch to step 525.

In step 525, the OCR module 416 of the mobile device 130 can perform OCR on the photograph of the receipt 140 and the photograph of the identifying information 152. The mobile device 130 can perform OCR on the photograph of the receipt 140 to produce textual data of the information listed on the receipt 140. Likewise, the mobile device 130 can perform OCR on the photograph of the identifying information 152 to produce a textual data that represents the identifying information 152. In one embodiment, step 525 can be omitted and performed by the refund processing server 110. Step 525 can branch to step 530.

In step 530, the refund submission module 134 of the mobile device 130 can determine if the photographs captured in step 520 include a photograph of identifying information 152. In some instances, the defective product 150 may not include identifying information 152. For example, produce may not include a sticker showing the identifying information 152. If the refund submission module 134 of the mobile device 130 determines that no photograph of identifying information 152 is available on the mobile device 130, step 520 branches to step 535. If the refund submission module 134 of the mobile device 130 determines that a photograph of identifying information 152 is available, step 520 branches to step 540.

In step 535, refund submission module 134 of the mobile device 130 can prompt, via the refund request GUI 416, a user to identify a defective product 150 on the receipt 140. The refund request GUI 416 can display a list of products that were purchased on the receipt 140. The mobile device 130 can use a touch screen to select a product from a list of products on the receipt 140. In one embodiment, the refund request GUI 416 can display a list of products on the receipt 140, each with an associated number. A user of the mobile device 130 can select a number from the list of numbers to select the defective product 150 on the receipt 140. Step 535 can branch to step 555.

In step 540, the refund submission module 134 of the mobile device 130 can identify the defective product 150 from the identifying information 152. The mobile device 130 can transmit, via the mobile device transceiver 136, a query to a remote database (not shown) of products and identifying information associated with those products. The mobile device 130 can transmit the query using the OCR results produced in step 525. The mobile device 130 can receive textual data identifying the defective product 150 based on the remote database query. Step 540 can branch to step 550.

In step 550, the refund submission module 134 of the mobile device 130 can determine if the defective product is on the receipt 140. The mobile device 130 can use the textual data received in step 540 to search the textual data produced by the receipt 140 OCR performed in step 525 to identify the defective product 150. The mobile device 130 can match the textual data received in step 540 with the textual data produced in step 525 as a basis of identifying the defective product 150. If the defective product 150 is identified, step 550 branches to step 555. If the defective product 150 is not identified, step 550 branches to step 545.

In step 545, the refund request GUI 416 of the mobile device 130 can display an error message. The error message can inform a user of the mobile device 130 that the defective product 150 that the user desires a refund for is not listed on the receipt 140. If a user of the mobile device realizes that the wrong receipt 140 was being used to request a refund, the mobile device process 500 can be restarted to allow the user to capture a photograph of the correct receipt 140. In such an instance where the mobile device process 500 is restarted, step 545 can branch to step 515.

In step 555, the refund submission module 134 of the mobile device 130 can formulate a refund request message comprising at least the photograph of the defective product 150 and any of the textual data produced by OCR performed in step 525. The mobile device 130 can transmit, via the mobile device transceiver 136, the textual data of receipt 140 and textual data of the identifying information 152 to the refund processing server 110. In one embodiment, the result of step 550 can produce metadata indicating that the defective product 150 is listed on the receipt 140. The mobile device 130 can formulate a request message including the metadata indicating that the defective product 150 is listed on the receipt 140 and transmit such metadata to the refund processing server 110. Step 555 can branch to step 560.

In step 560, refund request GUI 416 of the mobile device 130 can receive and display notification of a result of submitting a refund request for the defective product 150. The mobile device 130 can receive, via SMS, MMS, and/or email system 120, notification from the refund processing server 110 that a refund was granted. Likewise, the mobile device 130 can receive notification from the refund processing server 110 that a refund was denied and a reason for denial. The mobile device 130 can receive a text message and can display the text message on a display of the mobile device 130. The notification can include the money amount being refunded and the type of refund applied, e.g., credit card, store credit, store loyalty card, etc.

The refund submission module 134 can also be used for advertising via at least one of SMS, MMS, and/or email messages. The refund submission module 134 can track reward points being applied to a customer reward program. The mobile device 130 can include a location component (e.g., Global Positioning System (GPS) capability) for allowing advertisers to advertise location specific sales and specials.

The present invention can be implemented in any mobile device that is configured to transmit SMS, MMS and/or email messages, including cell phones, laptop computers, tablet computers, etc.

While the invention has been described with reference to the exemplary preferred embodiments thereof, those skilled in the art will be able to make various modifications to the described embodiments of the invention without departing from the true spirit and scope of the invention.

What is claimed is:

1. A refund requesting device, comprising:
a camera to capture a defective product photograph of a defective product and a receipt photograph of a purchase receipt for said defective product; and
an optical character recognition (OCR) module to optical character recognize said receipt photograph to produce receipt textual data; and
a transmitter to transmit, to a refund processing server, a refund request message comprising at least one of said defective product photograph and said receipt textual data;
wherein said refund processing server processes said refund request message to add a refund money amount to an account associated with a purchaser of said defective product.

2. The refund requesting device according to claim 1, wherein said camera captures an identifying information photograph of identifying information associated with said defective product.

3. The refund requesting device according to claim 2, wherein said identifying information is a universal product code (UPC).

4. The refund requesting device according to claim 2, wherein said OCR module optical character recognizes said identifying information to produce textual identifying data, and said transmitter further transmits said textual identifying data to said refund processing server.

5. The refund requesting device according to claim 1, wherein said refund requesting device is one of a cell phone, a laptop computer, and a tablet computer.

6. The refund requesting device according to claim 1, wherein said transmitter is at least one of short message service (SMS), a multimedia messaging service (MMS), and an email transmitter.

7. A method of requesting a refund for a defective product, comprising:
capturing, with a camera of a refund requesting device, a defective product photograph of said defective product and a receipt photograph of a purchase receipt;
optical character recognizing, with an optical character recognition (OCR) module of said refund requesting device, said receipt photograph to produce receipt textual data; and
transmitting, to a refund processing server with a transmitter of said refund requesting device, a refund request message comprising said receipt textual data and said defective product photograph;
wherein said refund processing server applies a refund money amount for said defective product to an account associated with a purchaser of said defective product.

8. The method of requesting a refund for a defective product according to claim 7, further comprising:
capturing, with said camera of said refund requesting device, an identifying information photograph of identifying information associated with said defective product.

9. The method of requesting a refund for a defective product according to claim 8, wherein said identifying information is a universal product code (UPC).

10. The method of requesting a refund for a defective product according to claim 8, further comprising:
optical character recognizing, with said optical character module of said refund requesting device, said identifying information photograph to produce identifying data associated with said identifying information; and
transmitting, with said transmitter of said refund requesting device, said refund request message further comprising said identifying data.

11. The method of requesting a refund for a defective product according to claim 7, wherein said refund requesting device is one of a cell phone, a laptop computer, and a tablet computer.

12. The method of requesting a refund for a defective product according to claim 7, wherein said transmitter is at least one of a short message service (SMS), multimedia messaging service (MMS), and email transmitter.

13. A refund processing server, comprising:
a receiver to receive a refund request message from a refund requesting device, said refund request message comprising at least a defective product photograph of a defective product;
a graphic user interface (GUI) to display said defective product photograph; and
an account access module to add a refund money amount to an account associated with a purchaser of said defective product in response to said refund request message.

14. The refund processing server according to claim 13, wherein said refund request message further comprises an identifying information photograph of identifying information associated with said defective product.

15. The refund processing server according to claim 14, wherein said identifying information is a universal product code (UPC).

16. The refund processing server according to claim 13, further comprising:
an optical character recognition (OCR) module to optical character recognize a purchase receipt photograph received with said refund request message to produce receipt textual data;
wherein said account access module adds said refund money amount to said account in response to said receipt textual data being associated with said defective product.

17. The refund processing server according to claim 13, wherein said refund requesting device is one of a cell phone, a laptop computer, and a tablet computer.

18. The refund processing server according to claim 13, wherein said receiver is at least one of a short message service (SMS), multimedia messaging service (MMS), and email transmitter.

19. A refund processing method, comprising:
receiving, via a receiver of a refund processing server, a refund request message from a refund requesting device, said refund request message comprising at least a defective product photograph of a defective product;
displaying, via a graphic user interface (GUI) of said refund processing server, said defective product photograph; and
accessing, via an account access module of said refund processing server, an account of a purchaser of said defective product to add a refund money amount to said account.

20. The refund processing method according to claim 19, wherein said refund request message further comprises an identifying information photograph of identifying information associated with said defective product.

21. The refund processing method claim 20, wherein said identifying information is a universal product code (UPC).

22. The refund processing method claim 19, further comprising:
optical character recognizing, with an optical character recognition (OCR) module of said refund processing server, a purchase receipt photograph received with said refund request message to produce receipt textual data; and
adding, with said account access module, said refund money amount to said account in response to said receipt textual data being associated with said defective product.

23. The refund processing method according to claim 19, wherein said mobile device is one of a cell phone, a laptop computer, and a tablet computer.

24. The refund processing method according to claim 19, wherein said receiver is at least one of a short message service (SMS), multimedia messaging service (MMS), and email transmitter.
